(19) United States
(12) Patent Application Publication
(10) Pub. No.: US 2012/0196463 A1
(43) Pub. Date: Aug. 2, 2012

(54) HOSTILE ENVIRONMENT ELECTRICAL HOUSING, ENDCAP AND METHOD

(76) Inventors: Mark H. Marvin, Tacoma, WA (US); Dmitry Feldman, Seattle, WA (US)

(21) Appl. No.: 13/361,944

(22) Filed: Jan. 30, 2012

Related U.S. Application Data
(60) Provisional application No. 61/437,790, filed on Jan. 31, 2011.

(51) Int. Cl. H01R 13/40; H01R 13/52; H01R 43/00

(52) U.S. Cl. 439/271; 29/825; 439/625

(57) ABSTRACT

A hostile environment electrical housing, associated endcap and method are described. A housing body is electrically conductive and defines a housing opening that leads into a housing cavity. An elongated electrically conductive member can be resiliently captured between the housing to form a plurality of electrical contacts between the housing body and the endcap as part of an electrical circuit. A spring can be fixedly engaged to the endcap by a crimping arrangement that is integrally formed with the endcap. An endcap assembly including the endcap and the elongated electrically conductive member can be provided for installation on a pre-existing housing body.

### RELATED APPLICATION

The present application claims priority from U.S. Provisional Patent Application Ser. No. 61/437,790, filed on Jan. 31, 2011, which is incorporated herein by reference in its entirety.

### BACKGROUND

The present application is generally related to an electrical housing assembly and, more particularly, to a housing assembly, electrical housing cap contact member and method, with applicability to a hostile operating environment.

In drilling applications such as, for example, horizontal directional drilling, a drill rig located at an aboveground location is used to extend and retract a drill string that is connected to an inground tool such as, for example, a boring tool or reamer. It is often desirable to provide a flow of drilling fluid through the drill string to the inground tool. The latter emits the drilling fluid in some manner such that the drilling fluid thereafter flows up the borehole around the periphery of the drill string. The inground tool can house battery powered equipment such as, for example, a transmitter that can transmit an electromagnetic locating signal that can be received above the surface of the ground and provide information relating to the position and/or operating parameters of the inground tool that may be of interest. The downhole environment, however, can be particularly hostile with respect to the battery powered equipment. Generally, the battery powered equipment can be located in a tubular housing having endcaps that are intended to seal the housing. In this regard, the drilling fluid can be under some amount of pressure, even in the borehole after being emitted by the inground tool, and can find its way at least partially into the housing of the battery powered equipment along any available path of opportunity such as, for example, between the endcaps and the tubular body of the housing.

Some embodiments of downhole battery powered equipment utilize the endcap as part of an electrical circuit. Since contamination and its sources are ubiquitous, for example, in the forms of dirt and fluid which can find its way into an interface between components such as a threaded connection, designs which rely on such connections for purposes of electrical contact can be subject to intermittent and/or open circuit conditions. Sources of contamination can include, by way of non-limiting example, handling by operators as well as the drilling or downhole environment. In this regard, Applicant has encountered this problem in an embodiment of battery powered equipment that utilizes threaded engagement between the endcap and body. That is, the connection between the threads of the cap and the threads of the body can become sufficiently fouled so as to interfere with an electrical connection between these components.

Previous methods to alleviate the problem include adding a ball plunger placed radially into the threaded area of the tubular body such that the ball rides on the crest of a mating thread of the cap. Unfortunately, this method is recognized by Applicant as having numerous problems including difficulty in placing the threaded hole, adjusting the ball plunger, high cost and also being subject to fouling. In this latter regard, each ball plunger arrangement adds only one relatively complex electrical path between the cap and body. Further, this electrical path is subject to fouling at numerous points including between the plunger body and ball itself.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Generally, a housing assembly includes a housing body that is electrically conductive and defines a housing opening that leads into a housing cavity. The housing cavity can receive components that include but are not limited to a battery and related electrical components. In an embodiment, an endcap is electrically conductive and removably receivable on the housing body to close the housing opening. An elongated electrically conductive member can be resiliently captured between the housing body and the endcap to extend at least partially around the housing opening when the endcap is engaged with the housing body to form a plurality of electrical contacts between an inner surface of the housing body and the electrically conductive member and between the endcap and the electrically conductive member which can form part of an electrical circuit. In one feature, a spring member can be fixedly engaged to the endcap by a crimping arrangement that is integrally formed with the endcap such that the spring member maintains electrical contact with the endcap and a distal end of the spring member electrically contacts one terminal of a battery received in the housing cavity when the endcap is received on the housing body.

In an embodiment, an endcap arrangement is configured for an electrically conductive housing body having a housing opening that leads into a housing cavity. The endcap arrangement includes an endcap that is electrically conductive and removably receivable on the housing body to close the housing opening and an elongated electrically conductive member for resilient capture between the housing body and the endcap. The conductive member extends at least partially around the housing opening when the endcap is engaged with the housing body to form a plurality of electrical contacts between an inner surface of the housing body and the electrically conductive member and between the endcap and the electrically conductive member which can form part of an electrical circuit.

In an embodiment, a housing assembly includes a housing body that is electrically conductive and defines a housing opening that leads into a housing cavity for receiving at least one battery. An endcap is electrically conductive and removably receivable on the housing body to close the housing opening. The endcap includes an integrally formed electrically conductive crimping arrangement for supporting an electrically conductive spring member in a crimped engagement such that the spring member maintains electrical contact with the endcap and a distal end of the spring member electrically contacts one terminal of the battery when the endcap is received on the housing body.

In an embodiment, an endcap arrangement is configured for an electrically conductive housing body having a housing opening that leads into a housing cavity. The endcap arrangement includes a spring member that is electrically conductive and an endcap that is electrically conductive and removably receivable on the housing body to close the housing opening. The endcap includes an integrally formed electrically conductive crimping arrangement for supporting the spring member in a crimped engagement such that the spring member maintains electrical contact with the endcap and a distal end of the spring member electrically contacts one terminal of a battery that is received in the housing cavity when the endcap is received on the housing body.

In an embodiment of a method according to the present disclosure, an electrical connection is formed between a housing body, that is electrically conductive and which defines a housing opening that leads into a housing cavity, and an endcap that is electrically conductive. An elongated electrically conductive member is resiliently captured between the housing body and the endcap to extend at least partially around the housing opening when the endcap is engaged with the housing body to form a plurality of electrical contacts between the housing body and the electrically conductive member and between the endcap and the electrically conductive member as part of an electrical circuit.

In another embodiment of a method according to the present disclosure, an electrical connection is formed between an endcap that is electrically conductive and a battery that is received in a housing cavity of a housing body with the housing body defining a housing opening that leads into the housing cavity. A spring member is formed, which is electrically conductive, to include a base ring. A crimping arrangement is integrally formed as part of the endcap for crimpingly engaging the base ring such that the spring member maintains electrical contact with the endcap and a distal end of the spring member electrically contacts one terminal of the battery received in the housing cavity when the endcap is received on the housing body to close the housing opening.

In addition to the exemplary aspects and embodiments described above, further aspects and embodiments will become apparent by reference to the drawings and by study of the following descriptions.

### BRIEF DESCRIPTIONS OF THE DRAWINGS

Exemplary embodiments are illustrated in referenced figures of the drawings. It is intended that the embodiments and figures disclosed herein are to be illustrative rather than limiting.

FIG. 1 is a diagrammatic view, in elevation and partially in cross-section, of a battery powered assembly including a housing and endcap assembly according to the present disclosure.

FIG. 2 is a diagrammatic view, in partial cross-section, of the assembly of FIG. 1 taken generally along a line 2-2 of FIG. 1, shown here to illustrate further details with respect to the housing, an associated endcap and an electrically conductive resilient contact member.

FIG. 3 diagrammatically illustrates another embodiment of the endcap and housing of FIGS. 1 and 2, shown here to illustrate details of its structure.

FIG. 4 is a diagrammatic end view of a peripheral groove, that can correspond to peripheral grooves shown in FIGS. 1-3, which receive another embodiment of the electrically conductive resilient contact member.

FIG. 5 is a perspective view of an embodiment of the endcap assembly of FIGS. 1 and 2, shown here to illustrate details of its structure including an arrangement for engaging a contact spring.

FIG. 6 is a perspective, exploded view of the endcap assembly of FIG. 5.

FIG. 7 is a diagrammatic view, in cross-section, of the endcap assembly of FIGS. 5 and 6, illustrating a crimping ring in crimped engagement with a base coil of a spring to form an electrical connection therebetween.

FIG. 8 is a diagrammatic, partially fragmentary view, in elevation, of the endcap of FIGS. 5-7.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiment shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be used with respect to these descriptions, however, this terminology has be adopted with the intent of facilitating the reader's understanding and is not intended as being limiting. Further, the figures are not to scale for purposes of illustrative clarity.

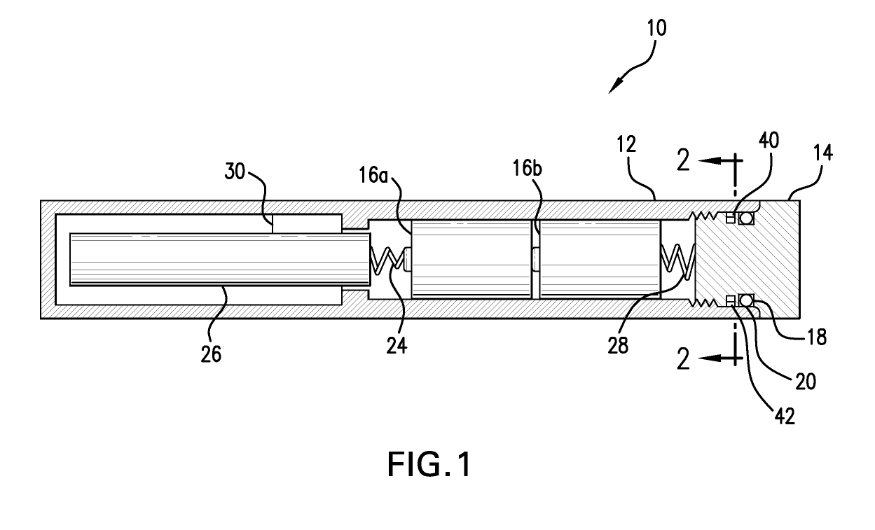

In view of the foregoing, attention is now directed to FIG. 1 which is a diagrammatic partially cutaway view, in elevation, of one embodiment of a battery powered assembly that is generally indicated by the reference numeral 10. Assembly 10 is suitable for use in downhole applications and produced according to the present disclosure. In the present embodiment, a housing 12 can be tubular (for example, cylindrical) although this is not a requirement and electrically conductive. The housing can be configured for threaded engagement with an endcap 14. Threaded engagement, however, is not required and any suitable form of engagement between the endcap and housing may be utilized such as, for example, set screws, and/or bayonet mount so long as the endcap is removable for purposes of replacing battery cells 16a and 16b, shown in a series connection to make up an overall battery. Endcap 14 can define an O-ring groove 18 which receives an O-ring 20 therein, although other suitable forms of sealing may be utilized. A contact 24 electrically connects one terminal of the battery to a load 26 to provide electrical power to the load. Another contact 28 can electrically connect the other terminal of the battery to cap 14. The load can be selected from a wide variety of different configurations but can include, by way of non-limiting example, sensors, associated electronics, transmitter electronics and/or receiver electronics. In the present embodiment, the batteries are shown as having the typical peripheral outline of well-known C size batteries although any suitable batteries can be used. Another terminal of the load can be electrically connected to housing 12 through a ground path 30. When endcap 14 is in electrical contact with the housing, the electrical ground circuit to load 26 can be completed by passing through contact 28, endcap 14, housing 12 and contact 30 to reach the other terminal of the battery. As discussed above, Applicant has discovered that during inground service, the mating threads on the endcap and housing can become fouled and are not considered as a reliable expedient for conducting battery power even when a seal such as, for example, O-ring 20 is present.

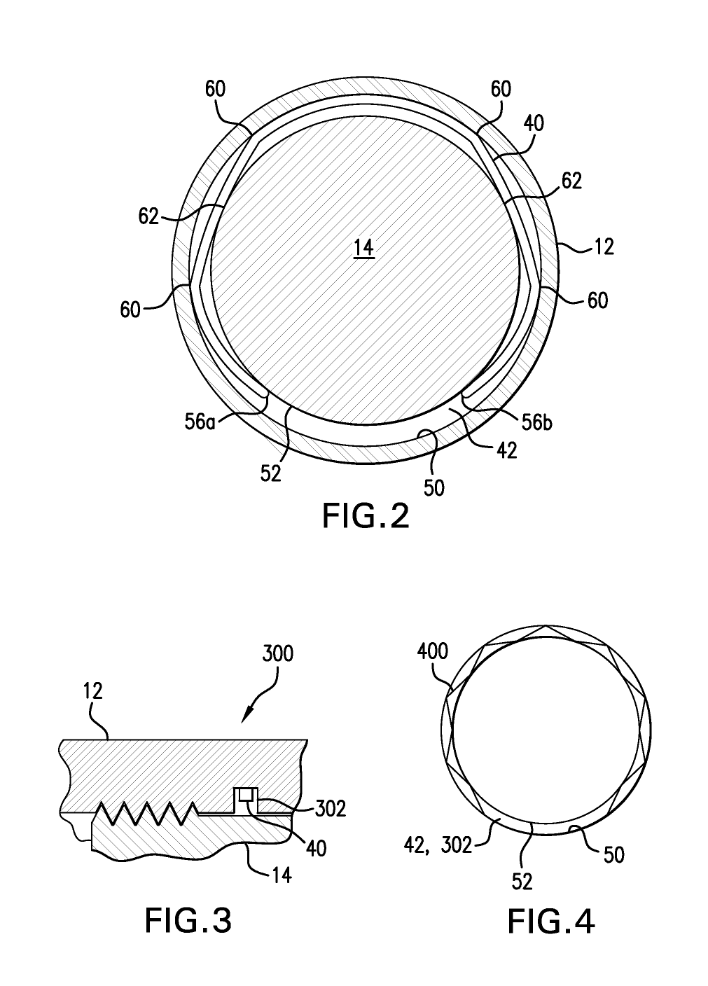

Turning now to FIG. 2 in conjunction with FIG. 1, the former is a diagrammatic view in partial cross-section, taken along a line 2-2 in FIG. 1. In order to overcome the foregoing problems and concerns, an electrically conductive, elongated resilient member 40 can be received in a peripheral groove 42 that can be defined by endcap 14. The electrically conductive resilient contact member can have any suitable shape in cross-section such as, for example, circular, rectangular (including square), closed polygonal and can be formed from any suitable electrically conductive material such as, for example, copper alloys and other suitable metallic alloys of sufficient yield strength. To enhance the electrical contact, suitable platings can be employed such as, for example, electroless nickel. In an embodiment, resilient contact member 40 can be formed from straight stock by appropriate bending. In an installed condition that is best illustrated by FIG. 2, resilient member 40 can be received within groove 42 defined by endcap 14 and captured between an inner surface 50 of housing 12 and a floor 52 of groove 42 of the endcap. It should be appreciated that groove 42 can be located on an inboard or inward side of O-ring seal 20 to further reduce or limit the potential for fouling. Resilient member 40 can readily be expanded for purposes of installation into groove 42. It should therefore be appreciated that the view of FIG. 2 illustrates the resilient member in a deformed state, although its appearance in an undeformed state is similar.

As is best seen in FIG. 2, resilient contact member 40 includes an elongated body that can extend more than one-half of the way (i.e., substantially) around a circular periphery of endcap 14 for purposes of retaining the member in groove 42 when the endcap is disengaged from the housing, although any suitable amount of arc length can be used by the resilient contact member within groove 42. Opposing ends 56a and 56b of the resilient contact member can be placed in a significantly spaced apart disposition with respect to one another in the groove or in near physical contact, as installed, while facilitating electrical continuity between the endcap and housing. In some embodiments, the opposing ends can overlap when installed at least to a limited extent. The resilient contact member can be formed to define a plurality of segments such that the segments adjoin to define electrical contacts against inner surface 50 of housing 12. In the example of FIG. 2, four contacts 60 are made with the inner surface of the housing using five segments. Simultaneously, opposing ends 56a and 56b of the resilient spring member can be formed to resiliently electrically contact floor 52 of groove 42 in the endcap. Additional electrical contact points 62 with the floor of groove 42, which may be referred to as intermediate electrical contact points, can be defined along the length of at least some of the segments. In some embodiments, electrical contacts defined by adjoining segments can resiliently contact the floor of groove 42 and/or inner surface 50 of the housing in a manner that will be further described below.

It should be appreciated that the cooperating geometry between the resilient contact member and the endcap, as well as the cooperating geometry between the resilient contact member and housing can be configured so as to generate what may be referred to as theoretical points of electrical contact. For example, if the resilient member includes a peripheral shape in cross-section that is defined by one or more curves, such theoretical points of electrical contact can be defined. More particular cross-sectional shapes which generate theoretical points of contact include, by way of example, circular and elliptical shapes. Such theoretical contact points can be useful in causing the mating/engaging geometry to produce a relatively higher level of contact force or stress as opposed to area or linear contacts that are purposefully defined as such from the standpoint of the design. The term theoretical electrical contact, as used herein, designates an attempt to form a point contact. Of course, since the mathematical definition of a point does not include an area, a theoretical point contact includes some area at least from a practical standpoint. The term electrical contact, as used hereinafter, can refer to such theoretical electrical contacts. The relatively higher levels of contact stress for theoretical electrical contacts may render theoretical contacts even less prone to fouling. The use of multiple contact points both inward engaging the endcap and outward engaging the housing can still further enhance the quality of the electrical circuit that is formed between the endcap and housing by the resilient contact member. Thus, resilient contact member 40 and its introduction produces a reliable electrical connection from battery cell 16b, through contact 28, through endcap 14, through resilient contact member 40, through housing 12, through ground contact 30 and to load 26.

In the present example, five segments have been illustrated as forming resilient contact member 40, however, any suitable number of fewer or greater segments can be employed. It is noted that the embodiment illustrated by FIGS. 1 and 2 includes a symmetrical shape having a pair of end segments connected to a pair of intermediate segments and a middle segment connecting the intermediate segments. It is noted, however, that such symmetry is not required.

Referring to FIG. 3, another embodiment of the endcap and housing of FIGS. 1 and 2 is shown in a diagrammatic fragmentary view and generally referred to by the reference number 300. A peripheral groove 302 is defined by housing 12 and receives resilient spring contact member 40. The latter can initially be compressed to an extent that is sufficient for purposes of installation into the peripheral groove.

Referring to FIG. 4, a diagrammatic view of either groove 42 of FIG. 2 or groove 302 of FIG. 3 is seen having a resilient contact member 400 received therein. In this embodiment, resilient contact member 400 includes what may be referred to as a zig-zag configuration which provides a plurality of electrical contacts (theoretical or otherwise) to each of floor 52 of the endcap and inner surface 50 of the housing. It should be appreciated that the segments can be of any suitable length including of different lengths and/or of equal lengths. Accordingly, it should be appreciated that the resilient contact member can be configured in a virtually unlimited number of ways while remaining within the scope of the teachings that have been brought to light herein.

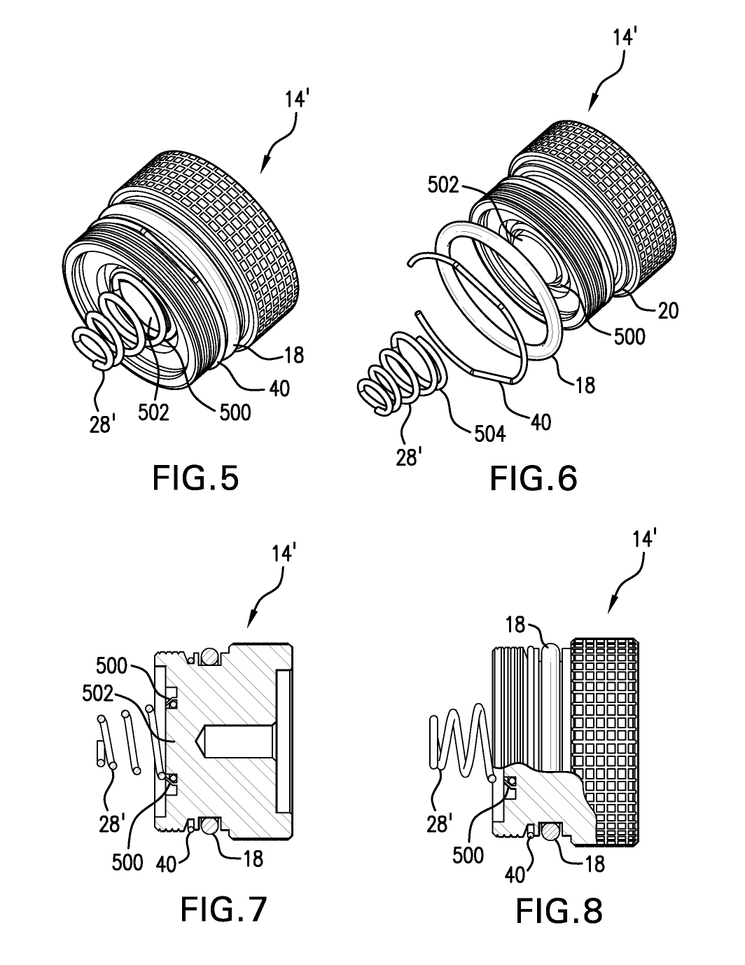

FIGS. 5 and 6 provide additional diagrammatic perspective views of an embodiment of the endcap, generally indicated by the reference number 14′, including associated components and resilient contact member 40. FIGS. 7 and 8 provide additional diagrammatic fragmentary views, in elevation. FIGS. 6-8, in particular, illustrate a crimping member 500 which can cooperate with a hub 502 to define a retaining recess which receives a base loop 504 (FIG. 6) of a conical coil spring 28′. It should be appreciated that the use of a conical coil spring is not intended as limiting and that any suitable form of resilient contact member may be used. Crimping member 500 can be continuous and circular, in one embodiment, in the form of a crimping ring. The latter is illustrated prior to crimping in FIG. 6 and post-crimping in FIGS. 7 and 8. In another embodiment, a plurality of crimping members in the form of crimping tabs can be provided in a spaced apart relationship around the periphery of hub 502. The appearance of FIGS. 7 and 8 can be representative of the appearance of such crimping tabs. It should be appreciated that the use of the crimping members such as the crimping ring and crimping tabs can provide a remarkably strong crimping force against base loop 504 for purposes of maintaining reliable electrical contact. An embodiment of any endcap described herein can be provided for use with a pre-existing housing body. For example, one embodiment can include an endcap body configured for supporting resilient contact member 40 along with the resilient contact member itself. Another embodiment can include an endcap body configured for crimping engagement with spring member 28′ along with the spring member itself. Still another embodiment can include the endcap body, the resilient contact member and the spring member. Further, either the resilient contact member and/or spring member can be provided independently for replacement purposes.

The use of the resilient contact member, as taught herein, overcomes the problems of the prior art while providing ease of installation. Further, there is no need for subsequent adjustment, it is low in cost, while providing a remarkable resistance to fouling and generates multiple contact points to each of the endcap and the housing. The resilient contact member can perform its intended function even when the endcap is not fully seated on the housing. All that is required is that the resilient contact member is captured between continuous surfaces defined by the endcap and the housing. For example, in the embodiment of FIG. 1, the endcap can be positioned within a range of lateral positions (left to right in the view of the figure) relative to the housing while still providing a plurality of electrical contacts between the continuous inner surface of the housing and the floor of the endcap groove. Of course, rotation of the contact member during installation or inground operation likewise does not affect its formation of the desired plurality of electrical contacts. Even if the endcap inadvertently becomes somewhat loose during operation, electrical contacts are maintained. It is noted that a wide variety of materials are suitable for the contact surfaces of the housing and endcap. In some embodiments, a corrosion resistant material, which can be a coating, can be applied to enhance conductivity. The material can be selected to have sufficient strength to withstand the stress resulting from the electrical contact loads.

The foregoing description of the invention has been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A housing assembly, comprising:
a housing body that is electrically conductive and defines a housing opening that leads into a housing cavity;
an endcap that is electrically conductive and removably receivable on the housing body to close the housing opening; and
an elongated electrically conductive member for resilient capture between the housing body and the endcap to extend at least partially around the housing opening when the endcap is engaged with the housing body to form a plurality of electrical contacts between an inner surface of the housing body and the electrically conductive member and between the endcap and the electrically conductive member which can form part of an electrical circuit.

2. The housing assembly of claim 1 wherein said elongated electrically conductive member includes first and second ends, each of which forms one of the electrical contacts.

3. The housing assembly of claim 1 wherein said elongated electrically conductive member is formed as a plurality of segments such that the segments adjoin to define at least one of the electrical contacts.

4. The housing assembly of claim 3 wherein said elongated electrically conductive member is formed in a zig-zag configuration of said segments to define said electrical contacts.

5. The housing assembly of claim 1 wherein a selected one of said housing body and said endcap defines a groove for receiving said elongated electrically conductive member.

6. The housing assembly of claim 5 wherein said endcap defines said groove having a groove floor and a subset of said electrical contacts is defined between the groove floor and the elongated electrically conductive member.

7. The housing assembly of claim 5 wherein said endcap defines an o-ring groove for receiving an o-ring to seal the housing cavity when the endcap is engaged with the housing body and said groove is inboard of said o-ring groove.

8. The housing assembly of claim 5 wherein the housing body is cylindrical such that the housing opening is circular and the elongated electrically conducive member is configured to extend more than one-half way around the circular housing opening.

9. The housing assembly of claim 1 wherein a cross-sectional shape of the elongated electrically conductive member is intended to produce at least one of said electrical contacts as a theoretical contact point.

10. The housing assembly of claim 9 wherein said cross-sectional shape is curved to produce said theoretical contact point.

11. The housing assembly of claim 10 wherein the cross-sectional shape is selected as one of circular and elliptical.

12. The housing assembly of claim 1 wherein said endcap and said housing body are configured for threaded engagement.

13. The housing assembly of claim 1 further comprising:
a spring member that is electrically conductive; and
said endcap further configured to include an integrally formed electrically conductive crimping arrangement for supporting said spring member in a crimped engagement such that the spring member maintains electrical contact with the endcap and a distal end of the spring member electrically contacts one terminal of a battery received in the housing cavity when the endcap is received on the housing body.

14. The housing assembly of claim 13 wherein said crimping arrangement includes a crimping hub spaced inward from a crimping ring such that the crimping hub and the crimping ring cooperate to define a crimping recess for receiving a base ring of said spring member in said crimped engagement.

15. An endcap arrangement configured for an electrically conductive housing body having a housing opening that leads into a housing cavity, said endcap arrangement comprising:
an endcap that is electrically conductive and removably receivable on the housing body to close the housing opening; and
an elongated electrically conductive member for resilient capture between the housing body and the endcap to extend at least partially around the housing opening when the endcap is engaged with the housing body to form a plurality of electrical contacts between an inner surface of the housing body and the electrically conductive member and between the endcap and the electrically conductive member which can form part of an electrical circuit.

16. The endcap arrangement of claim 15 wherein said elongated electrically conductive member includes first and second ends, each of which forms one of the electrical contacts.

17. The endcap arrangement of claim 15 wherein said elongated electrically conductive member is formed as a plurality of segments such that the segments adjoin to define at least one of the electrical contacts.

18. The endcap arrangement of claim 17 wherein said elongated electrically conductive member is formed in a zig-zag configuration of said segments to define said electrical contacts.

19. The endcap arrangement of claim 15 wherein said endcap defines a groove for receiving said elongated electrically conductive member.

20. The endcap arrangement of claim 19 wherein said endcap defines said groove having a groove floor and a subset of said electrical contacts is defined between the groove floor and the elongated electrically conductive member.

21. The endcap arrangement of claim 19 wherein said endcap defines an o-ring groove for receiving an o-ring to seal the housing cavity when the endcap is engaged with the housing body and said groove is inboard of said o-ring groove.

22. The endcap arrangement of claim 19 wherein the housing body is cylindrical such that the housing opening is circular and the elongated electrically conducive member is configured to extend more than one-half way around the circular housing opening.

23. The endcap arrangement of claim 15 wherein a cross-sectional shape of the elongated electrically conductive member is intended to produce at least one of said electrical contacts as a theoretical contact point.

24. The endcap arrangement of claim 23 wherein said cross-sectional shape is curved to produce said theoretical contact point.

25. The endcap arrangement of claim 24 wherein the cross-sectional shape is selected as one of circular and elliptical.

26. The endcap arrangement of claim 15 wherein said endcap is configured for threaded engagement with said housing body.

27. The endcap arrangement of claim 15 further comprising:
a spring member that is electrically conductive; and
said endcap further configured to include an integrally formed electrically conductive crimping arrangement for supporting said spring member in a crimped engagement such that the spring member maintains electrical contact with the endcap and a distal end of the spring member electrically contacts one terminal of a battery received in the housing cavity when the endcap is received on the housing body.

28. The endcap arrangement of claim 27 wherein said crimping arrangement includes a crimping hub spaced inward from a crimping ring such that the crimping hub and the crimping ring cooperate to define a crimping recess for receiving a base ring of said spring member in said crimped engagement.

29. An apparatus for use as part of an endcap arrangement configured for an electrically conductive housing body having an housing opening that leads into a housing cavity and the endcap arrangement further including an endcap body that is electrically conductive and removably receivable on the housing body to close the housing opening said apparatus comprising:
an elongated electrically conductive member for resilient capture between the housing body and the endcap body to extend at least partially around the housing opening when the endcap body is engaged with the housing body to form a plurality of electrical contacts between an inner surface of the housing body and the electrically conductive member and between the endcap body and the electrically conductive member which can form part of an electrical circuit.

30. A housing assembly, comprising:
a housing body that is electrically conductive and defines a housing opening that leads into a housing cavity for receiving at least one battery;
a spring member that is electrically conductive; and
an endcap that is electrically conductive and removably receivable on the housing body to close the housing opening and the endcap includes an integrally formed electrically conductive crimping arrangement for supporting said spring member in a crimped engagement such that the spring member maintains electrical contact with the endcap and a distal end of the spring member electrically contacts one terminal of said battery when the endcap is received on the housing body.

31. The housing assembly of claim 30 wherein said crimping arrangement includes a crimping hub spaced inward from a crimping ring such that the crimping hub and the crimping ring cooperate to define a crimping recess for receiving a base ring of said spring member in said crimped engagement.

32. The housing assembly of claim 31 wherein said crimping ring and said crimping hub cooperatively define a crimping recess.

33. The housing assembly of claim 30 wherein said crimping arrangement includes a crimping hub spaced inward from a plurality of crimping tabs such that the crimping hub and the crimping tabs cooperate to receive a base ring of said spring member in said crimped engagement.

34. An endcap arrangement configured for an electrically conductive housing body having an housing opening that leads into a housing cavity, said endcap arrangement comprising:
a spring member that is electrically conductive; and
an endcap that is electrically conductive and removably receivable on the housing body to close the housing opening and the endcap includes an integrally formed electrically conductive crimping arrangement for supporting said spring member in a crimped engagement such that the spring member maintains electrical contact with the endcap and a distal end of the spring member electrically contacts one terminal of a battery that is received in the housing cavity when the endcap is received on the housing body.

35. The endcap arrangement of claim 34 wherein said crimping arrangement includes a crimping hub spaced inward from a crimping ring such that the crimping hub and the crimping ring cooperate to define a crimping recess for receiving a base ring of said spring member in said crimped engagement.

36. A method for forming an electrical connection between a housing body, that is electrically conductive and which defines a housing opening that leads into a housing cavity, and an endcap that is electrically conductive, said method comprising:
resiliently capturing an elongated electrically conductive member between the housing body and the endcap to extend at least partially around the housing opening when the endcap is engaged with the housing body to form a plurality of electrical contacts between the housing body and the electrically conductive member and between the endcap and the electrically conductive member which can form part of an electrical circuit.

37. The method of claim 36 including configuring said elongated electrically conductive member as a plurality of segments such that the segments adjoin to define at least one of the electrical contacts.

38. The method of claim 37 wherein said elongated electrically conductive member is configured in a zig-zag configuration of said segments to define said electrical contacts.

39. The method of claim 36 including forming a groove in a selected one of said housing body and said endcap for receiving said elongated electrically conductive member.

40. The method of claim 39 including forming the groove to include a groove floor and establishing a subset of said electrical contacts between the groove floor and the elongated electrically conductive member.

41. The method of claim 39 wherein said endcap defines an o-ring groove for receiving an o-ring to seal the housing cavity when the endcap is engaged with the housing body and said groove is formed inboard of said o-ring groove.

42. The method of claim 39 wherein the housing body is cylindrical such that the housing opening is circular and configuring the elongated electrically conducive member to extend more than one-half way around the circular housing opening.

43. The method of claim 36 including selecting a cross-sectional shape of the elongated electrically conductive member to at least theoretically produce at least one of said electrical contacts as a theoretical contact point.

44. The method of claim 43 including selecting the cross-sectional shape as a curve to produce said theoretical contact point.

45. The method of claim 44 wherein the cross-sectional shape is selected as one of circular and elliptical.

46. The method of claim 36 including configuring said endcap to threadingly engage the housing body.

47. The method of claim 36 further comprising:
forming a spring member that is electrically conductive; and
configuring said endcap to include an integrally formed electrically conductive crimping arrangement for supporting said spring member in a crimped engagement such that the spring member maintains electrical contact with the endcap and a distal end of the spring member electrically contacts one terminal of a battery received in the housing cavity when the endcap is received on the housing body.

48. The method of claim 47 including spacing a crimping hub inward from a crimping ring, as parts of the crimping arrangement, such that the crimping hub and the crimping ring cooperate to define a crimping recess for receiving a base ring of said spring member in said crimped engagement.

49. A method for forming an electrical connection between an endcap that is electrically conductive and a battery that is received in a housing cavity of a housing body with the housing body defining a housing opening that leads into the housing cavity, said method comprising:
forming a spring member, which is electrically conductive, to include a base ring; and
integrally forming a crimping arrangement as part of the endcap for crimpingly engaging the base ring such that the spring member maintains electrical contact with the endcap and a distal end of the spring member electrically contacts one terminal of said battery received in the housing cavity when the endcap is received on the housing body to close the housing opening.
